(19) United States
(12) Patent Application Publication
(10) Pub. No.: US 2020/0021864 A1
(43) Pub. Date: Jan. 16, 2020

(54) SYSTEM FOR CONTROLLED ACCESS TO DIGITAL MEDIA CONTENT

(71) Applicant: Tiger Media Deutschland GmbH, Hamburg (DE)

(72) Inventor: Till Weitendorf, Hamburg (DE)

(73) Assignee: Tiger Media Deutschland GmbH, Hamburg (DE)

(21) Appl. No.: 16/508,500

(22) Filed: Jul. 11, 2019

(30) Foreign Application Priority Data
Jul. 11, 2018 (DE) 202018104005.7

(51) Int. Cl. H04N 21/239; H04W 4/80; H04N 21/454; H04N 21/4627

(52) U.S. Cl. CPC H04N 21/2396; H04N 21/4627; H04N 21/4542; H04W 4/80

(57) ABSTRACT

A system for controlled access to digital media contents includes a server computer, a computer network connection, at least one read/output device, and at least one information carrier. The server computer contains digital media contents; the read/output device is connectable via the computer network connection to the server computer; the information carrier saves at least one first information and at least one second information, which first information and which second information can be read by the read/output device; and the read/output device is configured to determine the first information and the second information of the information carrier and to transmit the first information and the second information to the server computer. The server computer, based on the result of a combined check of the first information and the second information, releases certain media contents for transmission to the read/output device, in order to display the media contents via the read/output device.

### INCORPORATION BY REFERENCE

The following documents are incorporated herein by reference as if fully set forth: German Patent Application No. 20 2018 104 005.7, filed Jul. 11, 2018.

### BACKGROUND

The invention relates to a system for controlled access to digital media contents.

Today, media contents, such as text, audio, video, or software applications (apps), as well as combinations thereof can be consumed without any problems at any time and quasi at any location, particularly via computer networks, such as the worldwide internet. This way, even for (smaller) children media contents can be provided, with however the verification of access control, particularly under the aspect of age appropriateness, representing an important aspect. Additionally it is important particularly for smaller children that the access to media contents can occur easily and, to the extent possible, in a game-like fashion.

### SUMMARY

The invention is based on the objective to provide a system for controlled access to digital media contents in a computer network by which even (smaller) children can access certain suitable media contents in a hazard-free and game-like fashion. Additionally the owner of the exploitation rights in the above-mentioned media contents shall be enabled to quantitatively limit access thereto.

This objective is attained in a system with one or more features of the invention. Advantageous variations of the system according to the invention are described below and in the claims.

The system according to the invention for controlled access to digital media contents includes: a server computer; a computer network connection; at least one read/output device; and at least one information carrier. The server computer contains digital media contents; the read/output device is or can be connected via the computer network connection to the server computer; the information carrier saves at least one first information and at least one second information, which first information and which second information can be read by the read/output device; the read/output device is designed and embodied to determine the first information and the second information of the information carrier and to transmit the first information and the second information to the server computer; and the server computer is designed and embodied, based on the result of a joint check of the first information and the second information, to release certain media contents for transmission to the read/output device, in order to display these media contents via the read/output device.

The (physical) information carrier is therefore mandatory in order to access the media contents. This allows efficient (quantitative) access control. Additionally it is possible to form the information carrier like a toy, a collection card, or the like such that added value results for the user (the child). Additionally, via the information carrier and the information saved thereon/therein here an unambiguous identification of certain media contents is possible to implement for example an effective age release. With the combined use of two information sources here a maximum protection from falsification and fraud is yielded. Furthermore, the card can be transferred or sold and the new owner is now also able to access the corresponding media contents.

In a first variant of the system according to the invention it is provided that the first information is saved by the information carrier via a NFC-readable code or in the form of an optic-digital code. Accordingly, the read/output device is designed and embodied to read the above-mentioned types of code, e.g., by the user directing the scanner (digital pen) to the code or bringing the information carrier into the proximity of a NFC-capable reading device.

NFC or near-field communication is an international transmission standard based on RFID-technology for the contactless exchange of data via electromagnetic induction using loosely coupled coils over short distances of a few centimeters and a data transmission rate of maximally 424 kBit/s. When here and in the following NFC is being discussed, this shall also cover alternative, similar communication technologies.

Optic-digital code is based preferably on a dot-matrix system printed on paper or the like. For example, the so-called digital paper is printed with a dot matrix showing a size of 0.1 mm at a distance of 0.3 mm. The position of the individual dots varies slightly and thus generates a visually detected digital code, which allows a scanner to detect the printed code on the paper. For this purpose an infrared camera in the scanner orients itself on this dot matrix in the background of the page. When here and in the following optic-digital code or optic code and/or OID is discussed, this shall also cover alternative similar coding technologies.

In a second variant of the system according to the invention it is provided that the second information is saved by the information carrier via a code that can be read via NFC or in the form of an optic-digital code. Accordingly, in this case as well the read/output device is designed and embodied to read the above-mentioned code types, e.g., by the user directing a scanner (digital pen) to the code or bringing the information carrier into the proximity of a NFC-capable reading device.

In a third variant of the system according to the invention it is provided that the information carrier is embodied in the form of a card with at least one printed optic-digital code and/or integrated NFC-chip. Such cards can be produced in a simple and cost-effective fashion and can be provided with images, text, and other content/decorations. As exchange or collection items they offer an additional value and can here be easily stored, e.g., in an appropriate collection album.

In another variant of the system according to the invention it is provided that the read/output device is embodied in the form of a (digital) pen, an audio-box (listening box), or a tablet PC. Pens of this type are known from prior art under the name Tiptoi® or Ting. They serve for reading optic code (OID or grid-code) and are linked via a wireless connection to the internet. Tablet PCs are known in various embodiments, including those having NFC-capacity. The so-called audio-box represents a special, particularly child-appropriate NFC-capable device, which is essentially designed only for playing audio content from the internet and is also linked via a wireless connection to the internet. The output can occur in the form of streaming in case of a constant internet connection or offline after prior downloading.

In yet another variant of the system according to the invention it is provided that a combined read/output device is provided for reading the first and second information and for displaying media content such that a particularly easy operation results because only a single device needs to be used. All above-mentioned devices may be considered, here.

In yet another variant of the system according to the invention it is provided that for reading the first and second information and for displaying the media content separate read/output devices are provided. For example a scanner may serve for reading the information which cooperates with an external speaker, a tablet PC, or an audio box in order to perform the display via a device separated from the scanner.

In a preferred variant of the system according to the invention it is provided to render available the media contents in the form of audio, video, e-book, or app-contents. The type of the respectively used media contents is here dependent on the type of the read/output device used: Audio contents are suitable e.g., for the audio box and the scanner, while videos and apps can only be used with the tablet PC.

In another preferred variant of the system according to the invention it is therefore provided that the server computer is designed and embodied for the transmission of metadata concerning the respective media contents to the read/output device. This metadata can specify in greater detail the type of media contents available.

In a particularly preferred variant of the system according to the invention it is further provided that the read/output device is designed and embodied to select useful media contents, particularly based on the above-mentioned metadata. This way the read/output device “detects” which type of media contents can be used.

In another variant of the system according to the invention it is provided that the connection between the read/output device and the server computer is generated in a wireless fashion, which has already been pointed out repeatedly. This can considerably increase the user comfort.

In another advantageous variant of the system according to the invention it is provided that the read/output device is designed and embodied to request media contents via transmission of the first information and the second information to the server computer. This way, the media contents can be secured against improper use.

The first information represents, in case of the use of a NFC-chip, preferably a so-called unique id (UID) of the chip, measuring for example 7 byte, which is predetermined by the factory and cannot be changed without considerable effort, if at all. The second information may then represent a security code, e.g. comprising 13 characters, which can be issued freely in principle and can accordingly also be falsified. Since it is provided within the scope of the invention to release certain media contents for transmission to the read/output device only as a result of a joint checking of the first information and the second information in order to display this media content via the read/output device it can be ensured that no unauthorized access occurs to the media contents. Although it is possible to gain access to the second information without authorization and to duplicate it, however in this case the corresponding first information would not match. If therefore the server computer comprises a “list” with permitted combinations of first and second information, it can reject the media requests that are based on an impermissible combination of the first and second information.

When using optic codes (OID codes, preferably OID3 codes), the first information preferably represents a first (initialization) code (a number) from a first value range from 0 and 200,000, stated as an example and without limitation. The second information may then represent another code (a number) from a second, particularly larger value range from 0 to 500,000, stated as an example and without limitation. The second information could be coded e.g., in the form of a “play” symbol. Due to the fact that within the scope of the invention it is provided that certain media contents are only released for transmission to the read/output device as a function of a result of a joint check of the first information and the second information in order to allow displaying media contents via the read/output device, it can also be ensured that no unauthorized access occurs to this media contents. However, it would be possible to obtain and duplicate one of the two information portions without proper authorization due to the limited value range, e.g., by a “brute force” attack. But, together with the other information here an excessive value range develops in practice. If therefore the server computer once more has available a “list” with permitted combinations from first and second information, it can reject media requests here too, which are based on an impermissible combination of first and second information.

In a particularly beneficial variant of the system according to the invention it is provided that the read/output device can be used only together with the information carrier to display media contents. This can be realized particularly when NFC-technology is used, because then it can be ensured that the read/output device can only be utilized when the information carrier is located in the proximity of the NFC-chip. Here the information carrier becomes more valuable.

Preferably, in one variant of the system according to the invention it is additionally provided that the information carrier unambiguously identifies certain media contents, perhaps as a function of a combination of first and second information. This has already been pointed out. This way, it can be ensured that particularly juvenile users can access only age-appropriate contents.

In the variant of the system according to the invention it may also be provided that the server computer is designed and embodied for the purpose to block certain media contents based on a combination of first information and second information for transmission to the read/output device when a combination of first information and second information during a predetermined time period has been transmitted more frequently than a predetermined number of times and/or by more than the predetermined number of read/output devices. This way it can be prevented that for example an information carrier with optic codes is simply copied. All copies would then show the same combination of first information and second information, and the server computer would recognize that this combination is repeated and transmitted by various devices and could block the transmission, preferably with this triggering the issue of a specific error message.

In another variant of the system according to the invention it may finally be provided that the information carrier, in addition to some optic-digital codes, preferably a plurality thereof, also includes a NFC-chip, with the server-computer being designed and embodied to release media contents regarding a combination of first and second information saved on the NFC-chip for transferal to the read/output device only when first a predetermined number, sequence, or selection of the optic-digital code or codes allocated to the combination has been transmitted by the read/output device to the server computer. This way a type of reward system can be established: Certain media contents are only available when first certain tasks or the like have been completed and/or questions answered. This occurs preferably via a (digital) pen, which is used to transfer a predetermined number, sequence, or selection of optic-digital codes allocated to the respective media contents to the server computer. For example and without limitation first a calculation problem must be solved, which is printed on the information carrier, by selecting with the pen the optic code corresponding to the solution, and thereafter the pen transmits the respective information to the server computer. The media content serving as a reward is then released and can be transmitted to the read/output device and displayed there based on the stipulations of the NFC-chip in cooperation with the server computer.

To the extent this application discusses “transmission” or “transmitting”, this includes in addition to classical downloading in all cases also streaming of the respective media content.

To the extent this application mentions that a device “is designed and embodied for the purpose” to perform a certain action or process, this may relate to a technical hardware embodiment, a technical software embodiment, a technical firmware embodiment of the device, or a combination thereof.

As stated in a preferred embodiment of the system according to the invention the following steps are required for accessing media contents via NFC card or OID:

a) The read/output unit or device (pen, box, tablet) must have access to the internet or a similar computer network (so-called “WLAN onboarding”).

b) The product code (code data on the NFC card or optic OID code, equivalent to the first and second information) is scanned (the product is equivalent to the information carrier defined at the outset).

c) This product code is sent for validation to the backend (server computer).

d) The backend receives the product code and checks,
d1) if two OID codes scanned (the first and the second information) represent in combination a valid product code and/or
d2) if a safety code (second information) in connection with an unambiguous NFC-chip ID (first information) represents a valid product code.

e) In case of invalid code combinations of first and second information the backend responds with an error message.

f) In case of a valid code combination the backend responds with metadata allocated to the corresponding product, which include links to the various media contents of the product (audio, video, e-book, app).

g) The device (also: terminal) selects the media content that can be displayed thereby and downloads it from the backend, with here it once more being possible to send the code combination as authorization.

h) In case of a valid code combination the backend supplies the media data to the device.

i) The media content intended for said device is then displayed.

Standard NFC-chips may be installed in the information carriers, which are purchased by the manufacturers of the card. Here, preferably the following standards are used:

The communication technologies and protocols used are in compliance with the standard ISO/IEC14443.

The memory capacities and functions of the chips are preferably in compliance with the definitions NTAG213 or NTAG216 (https://www.nxp.com/docs/en/datasheet/NTAG213_215_216.pdf).

The data is saved on the information carriers in the NFC Data Exchange Format (NDEF).

The front and/or back sides of the information carriers may be printed with OID codes (Codes for Optical Identification Device (OID)). They are also used by other manufacturers for access to media contents or they are used for coding information in printers.

As described in detail above, the information carriers include codes which allow access to media contents (audio books, videos, e-books, mobile apps). Depending on the functional capacities of the different read and output devices (speaker, monitor, input option) the content may be used in an audial, visual, or interactive fashion.

The authentication of the correct content for accessing the contents of an information carrier occurs preferably based on an unambiguous, hard to guess code as described above. It is scanned by the different read and output devices in various fashions (codes in the form of OIDs or NFC-data).

The access to the media contents occurs preferably based on the following steps:
A terminal (pen, (audio)-box or tablet) is connected via onboarding process to the internet (preferably via WLAN access).
The code (first and second information) is scanned (OIC or NFC data).
The code is preferably transmitted in an encrypted fashion via the internet (e.g., via SSL) to the backend (server computer).
The backend validates the code.
In case of a correct code the backend sends the product information to the terminal.
The terminal recalls the media contents from the backend, with once more here the code being used as the access key.
The terminal displays the media content (streaming) or downloads it for later (offline) use.

### BRIEF DESCRIPTION OF THE DRAWINGS

Additional features and advantages of the invention are discernible from the exemplary embodiments described in the following based on the drawing.

FIGS. 1A-1C show in various illustrations an information carrier that can be used within the scope of the invention.

FIGS. 2A-2C show another information carrier in various illustrations that can be used within the scope of the invention.

FIG. 3 shows various embodiments of the system according to the invention, and

FIG. 4 shows a flow chart of a method for accessing media contents processed in the system.

### DETAILED DESCRIPTION

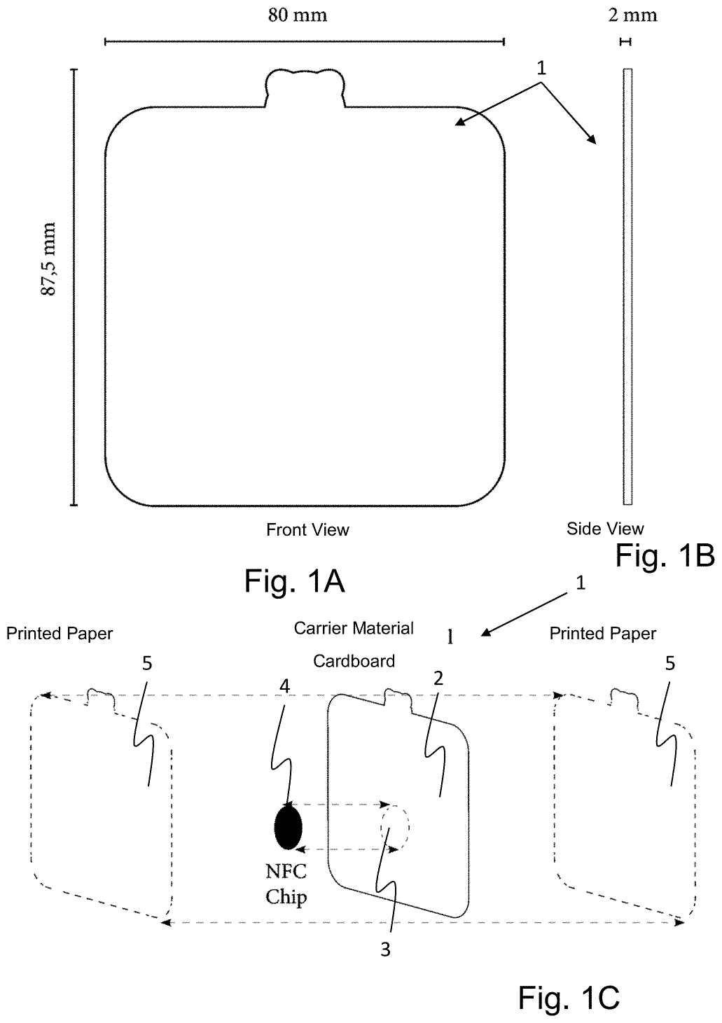

FIGS. 1A-1C show in various illustrations an information carrier 1 in the form of a collection card, which can be used within the scope of the invention. The dimensions stated and the shape are shown only as examples and have no restrictive effect.

FIG. 1C shows an exploded illustration of the information carrier 1. The information carrier 1 comprises a carrier material 2 made from cardboard or synthetic, with a NFC-chip 4 being inserted in a recess 3 located approximately in the center. Alternatively, the chip 4 may also be adhered in an area 3 on the carrier material. At both sides the carrier material 2 is coated with printed paper 5 (laminated), on which paper 5 images, text, or the like may be shown. Preferably there is a reference of the contents to the media contents that can be consumed via the information carrier 1. The NFC-chip 4 saves and/or includes the first and the second information (UID or safety code) as explained in detail at the outset.

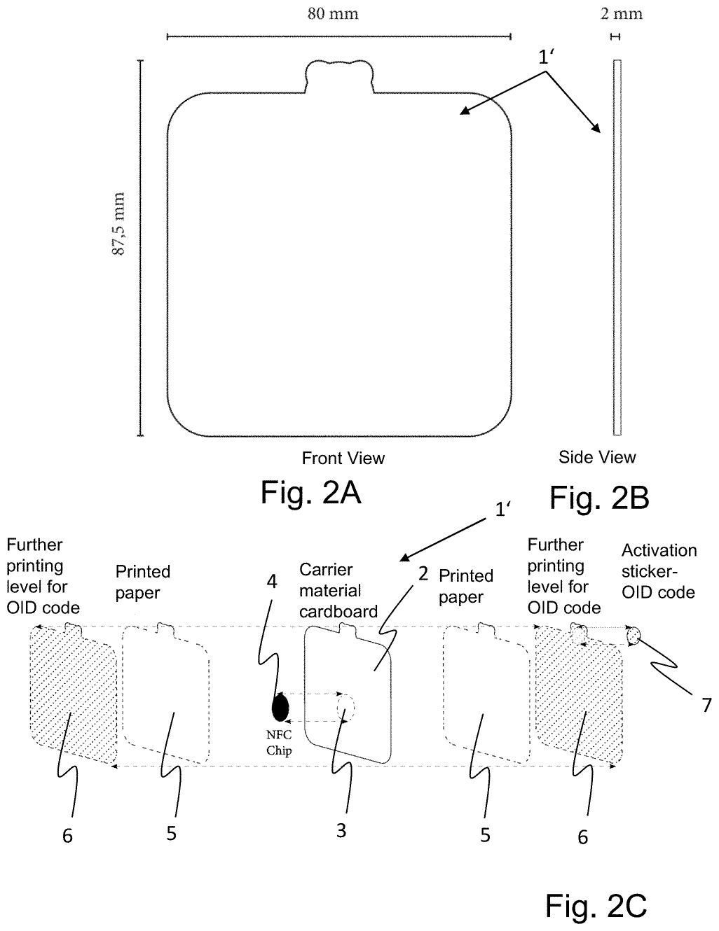

FIGS. 2A-2C show in various illustrations another information carrier 1′ that can be used within the scope of the invention. The dimensions stated and the shape are once more only provided as examples and have no limiting effect.

FIG. 2C shows an exploded illustration of the information carrier 1′. The information carrier 1′ includes a carrier material 2 made from cardboard or synthetic, in which a NFC-chip 4 is inserted in an approximately central recess 3. Alternatively, the chip 4 may also be adhered to an area 3 on the carrier material. At both sides the carrier material 2 is once more coated with printed paper 5 (laminated), on which paper 5 images, text, or the like may be printed. Preferably here too a reference to the content is provided of the media contents that can be consumed via the information carrier 1′. Additionally, at the reference character 6 another printing level (imprint) is provided for an OID code, which can be scanned with a suitable (digital) pen. This imprint 6 not necessarily covers the entire area but it may be limited to certain area sections of the information carrier 1′. For example, the imprint 6 may only be provided in a section in which the information carrier 1′ shows a display or “play” symbol (>) (not shown).

At the reference character 7 the information carrier 1′ comprises an additional activation sticker (label) which also carries an OID code. In case of the exclusive use of optic codes (OID codes, preferably OID3 codes) the OID code at the reference character 7 represents the coding of the first information, preferably a first (initialization) code (a number) from a first value range, for example and without limitation ranging from 0 to 200,000. The second information realized at the reference character 6 may represent then another code (a number) from a second, particularly greater value range, for example and without limitation ranging from 0 to 500,000. The second information may be coded in the form of a “play” symbol, as already mentioned.

The NFC-chip 4 may remain without a function in this exemplary embodiment; alternatively it may be used within the scope of the above-described reward system.

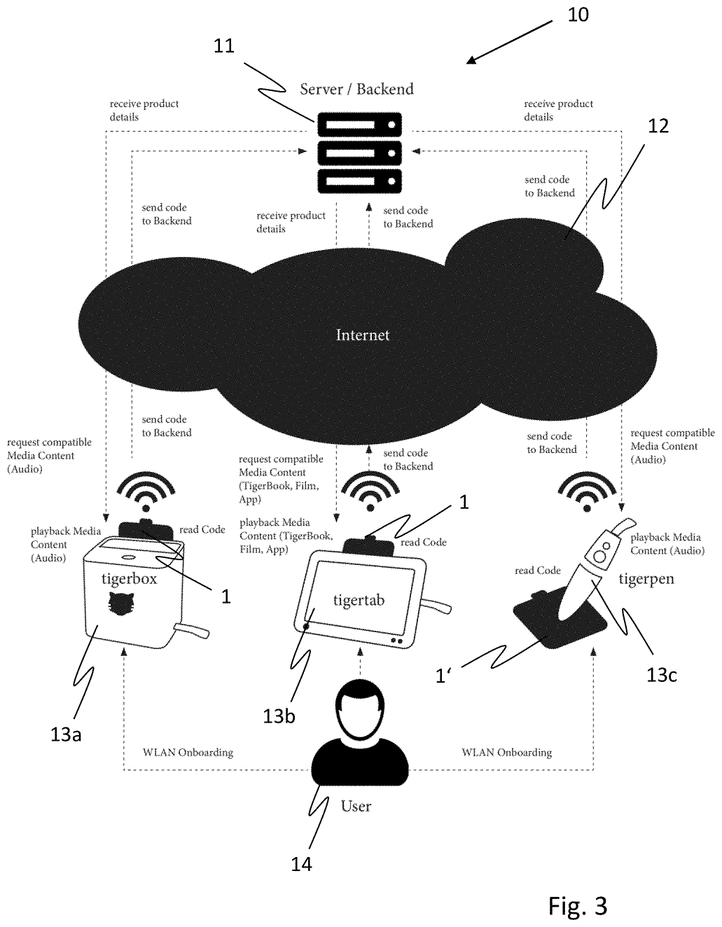

FIG. 3 shows schematically a system according to the invention for the controlled access to digital media content, which system overall is provided with the reference character 10. The system 10 comprises: a server computer (backend) 11; a computer network connection (the internet) 12; various read/output units (devices, terminals) 13a-13c, namely an audio box 13a, a tablet 13b, and a (digital) pen 13c; and respectively a suitable information carrier 1′, 1 for each terminal 13a-13c. The server computer 11 renders available the media contents (not shown) in question. The read/output device 13a-13c is connected via the computer network connection 12 to the server computer 11 and/or can be connected by an operator (user) 14, preferably in a wireless fashion via WLAN, as shown (“WLAN onboarding”). The respective information carrier 1′, 1 saves at least one first information and at least one second information, as described above based on FIGS. 1 and 2, which first information and which second information can be displayed by the respective read/output device 13a-13c, either via NFC or via OID-technology. Each read/output device 13a-13c is designed or embodied for determining the first information and the second information of the information carrier 1, 1′ (“read code” in FIG. 3) and for transmitting the first information and the second information to the server computer 11 (“send code to backend”). The server computer 11 is designed and embodied for the purpose, depending on the result of a check performed of jointly the first information and the second information, of releasing certain media contents for transmission to the requesting read/output device 13a-13c in order to display this media content via the read/output device 13a-13c. For this purpose first product details regarding the media contents allocated to the respective information carrier 1, 1′, is sent from the server computer 11 to the respective read/output device 13a-13c (“receive product details”), then the respective read/output device 13a-13c requests the suitable media content from the server computer 11 (“request compatible media content”), and displays it (“playback media content”). Preferably the user 14 brings the respective read/output device 13a-13c and the respective information carrier 1, 1′ into an effective connection and particularly ensures the reading/detecting of the above-mentioned OID/NFC code by the read/output device 13a-13c.

If the read/output device 13a, 13b is embodied as a tablet or audio-box, this may be equipped with a slot or gap or other clamping/holding device (not shown) for receiving an information carrier 1 embodied in particular as a card.

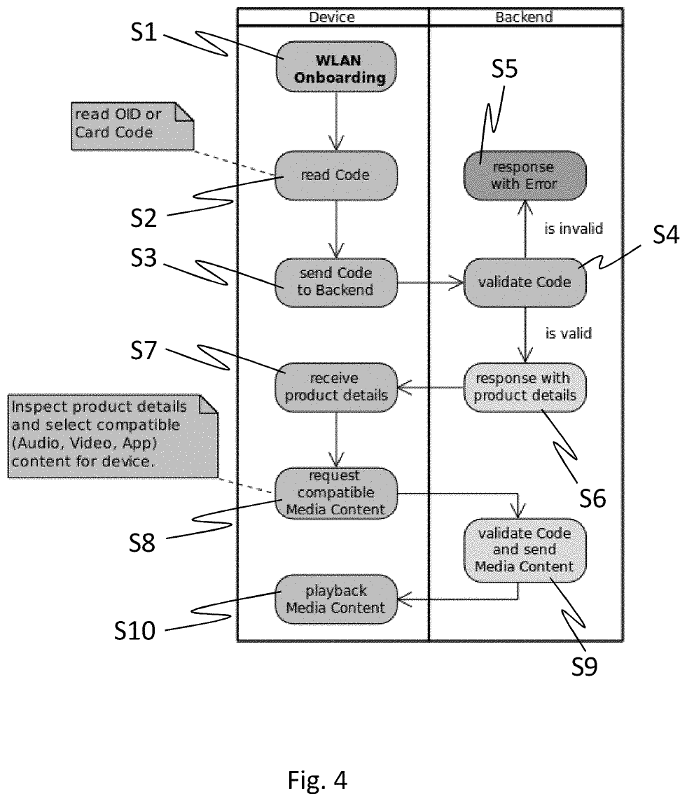

FIG. 4 shows the essential (procedural) steps as explained above based on FIG. 3 in the form of a flow chart. The read/output device (“device”) is granted access to the internet or a similar computer network in step S1 (so-called “WLAN onboarding”), via which it is connected to the server computer (“backend”). In step S2 the product code (code data on the NFC card (“card code”) or optic OID code, equivalent to the first and second information) is scanned via the read/output device (the product is equivalent to the information carrier defined at the outset). This product code is then sent in step S3 for validation from the read/output device to the backend (server computer). The backend receives the product code and checks (validates) in step S4 if two OID codes scanned (the first and the second information) represent in combination a valid product code or if a safety code (second information) in combination with an unambiguous NFC-chip ID (first information) represents a valid product code. This is called in FIG. 4 a “validated code” for both cases, with the code respectively being composed from the first and the second information, which are checked jointly, as explained above in detail. Preferably, for this purpose a list of permitted combinations of the first information and the second combination (sic) is available on the backend computer. In case of invalid code combinations comprising first and second information (“is invalid”), the backend responds in step S5 with an error message, which is preferably issued by the read/output device. The backend computer is in this context preferably also designed and embodied to block certain media contents from transmission based on a combination of first information and second information when a combination of first information and second information during a predetermined period was transmitted more frequently than stipulated for a predetermined number of attempts and/or by more read/output devices as predetermined, which is not explicitly shown in FIG. 4 and particularly in step S5. In case of a valid code combination (“is valid”) the backend responds in step S6 with the metadata (“product details”) for the corresponding product, which includes links to the various media contents of the product (audio, video, e-book, app). The read/output device receives this metadata in step S7 and selects in step S8 the media contents that can be displayed (“select compatible . . . content”). Then it requests said contents from the backend, with once more the code combination being transmitted for authentication. In case of a valid code combination (check in step S9) the backend provides the media data to the read/output device. The media contents intended for the read/output device are displayed in step S10.

1. A system (10) for controlled access to digital media contents, the system comprising:
a server computer (11) configured to provide digital media contents;
a computer network connection (12);
a read/output device (13a-13c) configured to be connectable or connected to via the computer network connection (12) to the server computer (11);
an information carrier (1, 1′) that includes at least one first information and at least one second information saved in a non-transitory media, said saved first information and said saved second information are scannable by the read/output device (13a-13c);
the read/output device (13a-13c) is configured to determine the first information and the second information from the information carrier (11) and to transmit the first information and the second information to the server computer (11); and
the server computer (11) is configured, based on a result of a combined check of the first information and the second information, to release certain of said digital media contents for transmission to the read/output device (13a-13c), in order to display said digital media contents via the read/output device (13a-13c).

2. The system (10) according to claim 1, wherein the first information is saved by the information carrier (1, 1′) via a code that is readable via NFC or as an optic-digital code.

3. The system (10) according to claim 1, wherein the second information is saved by the information carrier (1, 1′) via a code that is readable via NFC or as an optic-digital code.

4. The system (10) according to claim 1, wherein the information carrier (1, 1′) comprises a card with at least one of a printed optic-digital code or an integrated NFC-chip (4).

5. The system (10) according to claim 1, wherein the read/output device (13a-13c) comprises at least one of a pen (13c), an audio-box (13a), or a tablet PC (13b).

6. The system (10) according to claim 1, wherein read/output device (13a-13c) is further configured for scanning the first and second information and for displaying the media contents.

7. The system (10) according to claim 1, further comprising a separate output device configured to display the media contents separate from the read/output device.

8. The system (10) according to claim 1, wherein the digital media contents comprise at least one of audio, video, e-book, or app-contents.

9. The system (10) according to claim 1, wherein the server computer (11) is configured to transmit metadata regarding the respective media contents to the read/output device (13a-13c).

10. The system (10) according to claim 9, wherein the read/output device (13a-13c) is configured to select useful media contents based on the metadata.

11. The system (10) according to claim 1, wherein a connection between the read/output device (13a-13c) and the server computer (11) is embodied in a wirelessly.

12. The system (10) according to claim 1, wherein the read/output device (13a-13c) is configured to request media contents by transmitting the first information and the second information to the server computer (11).

13. The system (10) according to claim 1, wherein the read/output device (13a-13c) are useable only together with the information carrier (1, 1′) for displaying media content.

14. The system (10) according to claim 1, wherein the information carrier (1, 1′) unambiguously identifies certain media contents depending on a combination of the first and second information.

15. The system (10) according to claim 1, wherein the server computer (11) is configured to include a list of permitted combinations of first information and second information.

16. The system (10) according to claim 1, wherein the server computer (11) is configured to block certain media content from transmission to the read/output device (13a-13c) based on a combination of the first information and the second information when a combination of the first information and the second information during a predetermined period was at least one of transmitted more times than a predetermined number stipulated or by more than a predetermined number of different ones of the read/output devices (13a-13c).

17. The system (10) according to claim 1, wherein the information carrier (1, 1′) comprises a plurality of optic-digital codes (6, 7) and a NFC-chip (4), and the server computer (11) is configured to only release media contents for a combination of the first and second information saved on the NFC-chip (4) for transmission to the read/output device (13a-13c) when at least one of a predetermined number, sequence, or selection of the optic-digital code (6, 7) allocated to said combination have been transmitted by the read/output device (13a-13c) to the server computer (11).
